(19) United States
(12) Patent Application Publication
(10) Pub. No.: US 2019/0197548 A1
(43) Pub. Date: Jun. 27, 2019

(54) Systems and Methods for Providing Central Token Handling for Computing Networks

(71) Applicant: MASTERCARD INTERNATIONAL INCORPORATED, Purchase, NY (US)

(72) Inventors: Carole Lynne Kelly-Frank, Wildwood, MO (US); Aimee G. Musil, O'Fallon, MO (US)

(21) Appl. No.: 15/850,924

(22) Filed: Dec. 21, 2017

(51) Int. Cl. G06Q 20/40; G06Q 20/36; G06Q 20/12; G06Q 20/38; H04L 9/32

(52) U.S. Cl. CPC G06Q 20/4016; G06Q 20/367; H04L 9/32; G06Q 20/382; G06Q 20/12

(57) ABSTRACT

Systems and methods are provided for processing network transactions based on use of tokens in the transactions. An exemplary system includes a network having a memory and a processor coupled to the memory, where the memory includes a token vault data structure having a listing of tokens stored therein in association with corresponding account numbers. In connection therewith, the processor is configured to receive a network request message from a routing network different than the network, where the network request message includes a token associated with an account involved in a transaction but not an actual account number used in the transaction. In response to the network request message, the processor is configured to convert the token to an account number associated with the account, based on the listing of tokens in the token vault data structure, and transmit the account number to the routing network.

### FIELD

The present disclosure generally relates to systems and methods for providing central token handling for computing networks, and in particular, to systems and methods for detokenization of network messages from multiple different networks whereby tokens associated therewith may be provided from multiple different token providers.

### BACKGROUND

This section provides background information related to the present disclosure which is not necessarily prior art.

Network transactions often involve users, who initiate the transactions. In connection with such transactions, payloads of the transactions are known to be bases for how the transactions are handled and/or processed. It is common for transactions to rely on account indicators, within the payloads, such as account numbers, for routing, processing and/or replying to messages related to the transactions. It is also known for account numbers to be omitted for purposes of security, where tokens are provided in place of the account numbers. Specifically, for example, a payment network may rely on a token in some instances to mask or otherwise obscure a payment account number (e.g., a primary account number (PAN), etc.) from messages within the payment network and/or outside of the payment network (e.g., from a merchant, etc.). At some point in the payment network, the token is detokenized to reveal the payment account number for the account, thereby permitting routing, processing or approval of the underlying transaction, etc. Further, issuers often rely on token service providers to generate and provide tokens in connection with payment accounts, and also for the issuers to generate and/or provide tokens directly themselves.

### DRAWINGS

The drawings described herein are for illustrative purposes only of selected embodiments and not all possible implementations, and are not intended to limit the scope of the present disclosure:

FIG. 1 illustrates an exemplary system for use in handling tokens within computing networks and within corresponding network messages associated therewith, and including one or more aspects of the present disclosure;

FIG. 2 is a block diagram of an exemplary computing device that may be used in the system of FIG. 1; and

FIG. 3 is an exemplary method, which may be implemented via the system of FIG. 1, for converting a token to a payment account number, by a payment network, where a payment network message using the token is initiated in a different payment network.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transactions initiated at merchants, either in person or via network interactions, may result in authorization requests for the transactions, in which tokens are used rather than primary account numbers (PANs), for example, for payment accounts identified in the transactions. In connection with the transactions, the tokens are typically mapped or converted to the PANs, by token service providers issuing the tokens, to permit the transactions to proceed. When different token service providers, or different payment networks, are involved, issues may arise with the tokens, where the authorization requests may be processed by parties that are unable to map the tokens to the proper PANs.

Uniquely, the systems and methods herein provide for tokens to be converted to account numbers by a primary payment network, where network messages for transactions associated therewith are routed through different routing payment networks. In particular, when a routing payment network receives a network message (from an acquirer) for a transaction including a token unfamiliar to the routing payment network, a service request is directed to the primary payment network, which requests conversion or mapping of the token to an account number, such as, for example, a PAN, etc., associated with the specific account. Upon receipt of the account number from the primary payment network, the routing payment network provides the network message, with the account number, to an issuer of the account. Thereafter, the routing payment network directs a network reply message (as received from the issuer) to the acquirer from which the network message was initially received. In connection with the transaction, the issuer also provides transaction details to the account holder (e.g., a consumer involved in the transaction, etc.) at a communication device associated with the account holder. In this manner, when a network message is routed through the routing payment network, which is unfamiliar with the token identified in the message, the routing payment network is still able to identify the appropriate payment account, via a request to the primary payment network (i.e., to another payment network), and to continue routing of the network message. With that said, the primary payment network includes a token vault data structure that includes tokens from one or multiple token service providers, to thereby provide a central handling of token-inclusive network messages and subsequent detokenization of the same as needed. As such, efficiencies are gained herein over non-central handling of tokens, where network messages may be directed to disparate services and may be dependent on issuers associated with and/or generators of the specific tokens.

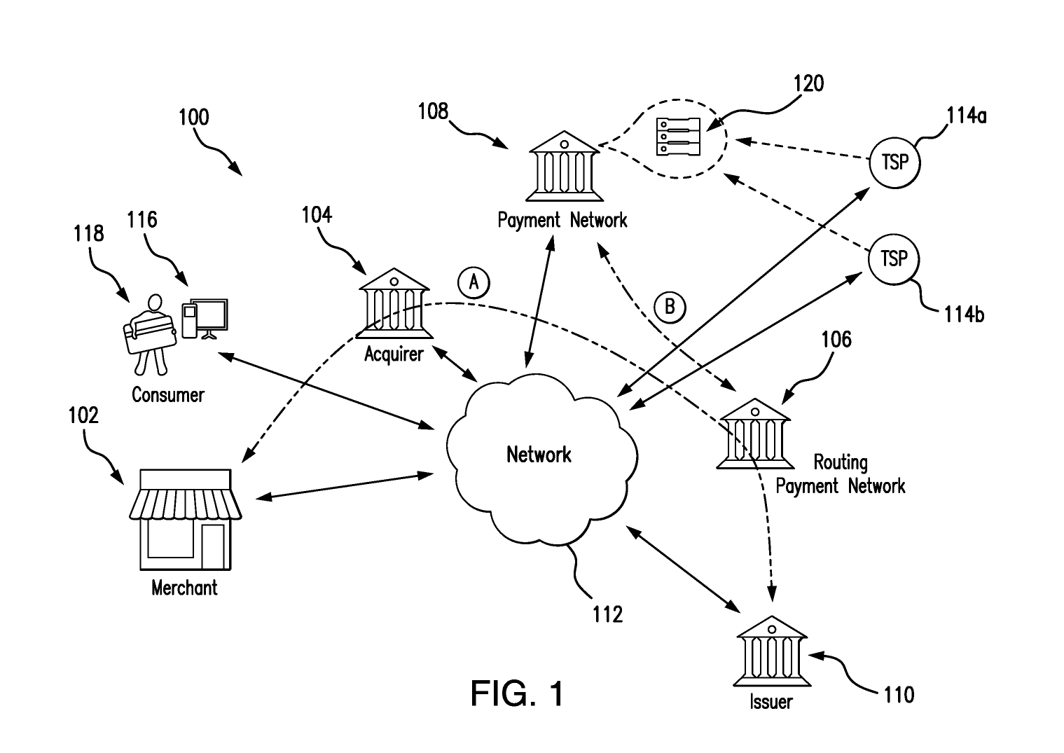

FIG. 1 illustrates an exemplary system 100 in which one or more aspects of the present disclosure may be implemented. Although the system 100 is presented in one arrangement, other embodiments may include systems arranged otherwise depending, for example, on a number of entities involved in issuing tokens (i.e., a number of token providers in the systems), a manner in which value-added services are invoked for transactions, sources of tokenization requests (e.g., merchants, virtual wallets, etc.), etc.

In the illustrated embodiment, the system 100 generally includes a merchant 102, an acquirer 104, a routing payment network 106, a payment network 108 (e.g., an issuer payment network, etc.), and an issuer 110, each coupled to (and in communication with) network 112. The system 100 also includes token service providers 114a and 114b, each coupled to and in communication with the network 112. That said, the network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the routing payment network 106 to the acquirer 104 and the issuer 110, and/or a private payment transaction network made accessible by the payment network 108 to the routing payment network 106 and the token service providers 114a-b, and, separately, the public Internet, which is accessible as desired to the merchant 102, the routing payment network 106, the payment network 108 and one or more various computing devices, such as, for example, a computing device 116 associated with a consumer 118, etc.

The merchant 102 in the system 100 is generally associated with products (e.g., goods and/or services, etc.) available for purchase by one or more consumers (including consumer 118). The merchant 102 may offer the products for sale to the consumer 118, for example, through a physical location and/or through a virtual location, etc.

The consumer 118 in the system 100 is associated with a payment account, which is issued by the issuer 110 and which is suitable for use in funding transactions for products at the merchant 102 (or at other merchants as desired). The issuer 110 generally issues payment accounts (including the payment account issued to the consumer 118) that are specific to particular payment networks. For example, in the illustrated embodiment, the issuer 110 is configured to issue the consumer's payment account (and potentially other payment accounts) in association with (but without limitation to) the routing payment network 106, whereby messaging associated with transactions to the issued payment account is routed through the routing payment network 106. As such, in this example, the routing payment network 106 is a “front of card” payment network for the consumer's payment account (and for other payment accounts issued in association with the payment network 106). Similarly, the issuer 110 may be configured to issue payment accounts in association with the payment network 108, whereby messaging associated with transactions to the issued payment accounts would be routed through the payment network 108. And, here, the payment network 108 is the “front of card” payment network for such payment accounts. Regardless, however, each of the payment networks 106 and 108 is configured to provide at least messaging between acquirers and issuers to facilitate payment account transactions to the various payment accounts.

With that said, it is possible for one or more transactions directed to the payment account of the consumer 118 to potentially be routed through the payment network 108 (even though issued in association with the routing payment network 106). For example, by agreement between the routing payment network 106 and the payment network 108, the payment network 108 may be configured to route all transactions of a certain type (e.g., all debit transactions, all ATM transactions, etc.) or all transactions for a certain location between corresponding acquirers and issuers, for processing as described in more detail below.

With continued reference to FIG. 1, the token service providers 114a-b of the system 100 are configured to provide token services for the issuer 110, for example. Specifically, in connection with the payment accounts issued by the issuer 110, the token service providers 114a-b may generate and provision tokens for the payment accounts, and then provide mappings of the tokens back to the payment accounts. The tokens may then be disseminated by consumers in lieu of account numbers for the given accounts, for purposes of security, fraud prevention, etc. In this exemplary embodiment, the token service provider 114a is associated with the issuer 110, such that the token service provider 114a generates and provisions tokens for accounts on behalf of the issuer 110 (including to the consumer 118, for example, for his/her account).

Each of the token service providers 114a-b is illustrated as being a separate part of the system 100, for example, separate from the payment network 108 and the routing payment network 106 (e.g., as third party service providers, etc.). That said, one or both of the token service providers 114a-b may be incorporated (physically or by control/agreement, etc.) into the routing payment network 106 and/or the payment network 108 in other embodiments. For example, in at least one embodiment, the token service provider 114a may be a separate, standalone part of the system 100, while the token service provider 114b may be incorporated into the payment network 108.

Generally, while one merchant 102, one acquirer 104, two payment networks 106 and 108, one issuer 110, and two token service providers 114a-b are included in the system 100 illustrated in FIG. 1, it should be appreciated that any number of these parts (and their associated components) may be included in the system 100, or may be included as a part of systems in other embodiments, consistent with the present disclosure. Likewise, it should be understood that other system embodiment may include additional consumers and associated computing devices, which operate substantially similar to the description herein.

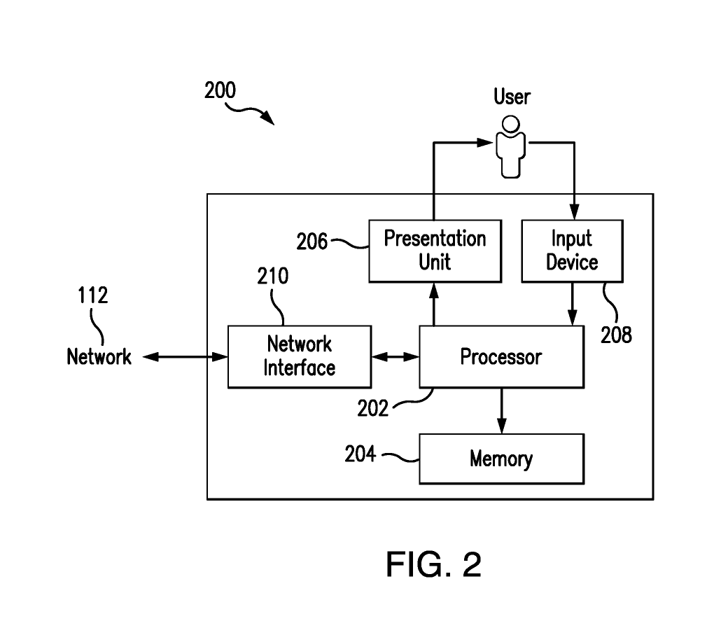

FIG. 2 illustrates an exemplary computing device 200 that can be used in the system 100. The computing device 200 may include, for example, one or more servers, workstations, personal computers, laptops, tablets, smartphones, PDAs, point-of-sale (POS) devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the merchant 102, the acquirer 104, the payment networks 106 and 108, the issuer 110, and the token service providers 114a-b may include, or may be implemented in, at least one computing device consistent with the computing device 200 and coupled to the network 112. In addition, the consumer's computing device 116 may be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, tokens, token maps, account numbers (e.g., PANs, etc.), account ranges, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., tokens, etc.), either visually or audibly to a user of the computing device 200, for example, the consumer 118 in the system 100, users associated with other parts of the system 100, etc. Various interfaces (e.g., as defined by network-based applications, webpages, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selections to purchase products, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth™ adapter, etc.), a mobile network adapter, or other device capable of communicating to/with one or more different networks, including the network 112. Further, in some exemplary embodiments, the computing device 200 may include the processor 202 and one or more network interfaces (including the network interface 210) incorporated into or with the processor 202.

Referring again to FIG. 1, the system 100 further includes a token vault data structure 120. In the illustrated embodiment, the token vault data structure 120 is associated with the payment network 108. In connection therewith, the token vault data structure 120 may be a standalone computing device associated with or within the payment network 108 (consistent with computing device 200), or it may be incorporated into the computing device in which the payment network 108 is implemented. Regardless, the token vault data structure 120 includes tokens issued by the token service providers 114a-b, and by other token service providers, interacting with the payment networks 106 and 108 (and potentially with other payment networks), etc. Specifically, when a token is generated and provisioned to a consumer for a payment account by one of the token service providers 114a-b (and provided to the consumer as appropriate), for example, the one of the token service providers 114a-b is configured to transmit the generated token to the token vault data structure 120 (as indicated by the dashed arrowed lines in FIG. 1), along with an identification of the payment account with which the token is associated. In turn, the token vault data structure 120 is configured to generate and store the token into a token map. The token map includes a listing of each known token and also the account number (e.g., the PAN, etc.) for the account associated with the token. Thereafter, the payment network 108, and also the token vault data structure 120, may be configured to respond to requests related to tokens listed in the token map therein.

As an example, the token service provider 114a may provision a token to the consumer 118 for his/her payment account (where, as described above, the payment account is issued to the consumer 118 by the issuer 110 and is specific to the routing payment network 106). Subsequently, in connection with a transaction between the consumer 118 and the merchant 102 involving the payment account, the consumer 118 may present the token (as associated with the consumer's payment account) to the merchant 102 in connection with funding the transaction (instead of an account number for the consumer's payment account, whereby the transaction includes/involves the token but not the actual account number or actual alpha-numeric digits representative of the account number). The token may be presented, for example, via a payment application included in the computing device 116 associated with the consumer 118, or otherwise. In turn, the merchant 102 is configured to receive the token and compile an authorization request for the transaction (e.g., including the token associated with the account; an amount of the purchase; a cryptogram associated with enhanced authentication operations, if any; etc.). The merchant 102 is configured to then transmit the authorization request to the acquirer 104, along path A in FIG. 1. And, the acquirer 104 is configured to communicate the authorization request with the issuer 110 along path A, generally through the routing payment network 106, such as, for example, through one of MasterCard®, VISA®, Discover®, American Express®, etc., as described more hereafter.

In particular, upon receipt of the authorization request (and prior to relaying the authorization request to the issuer 110), the routing payment network 106 is configured to determine whether the token included therein is known and/or familiar to the payment network 106. If the token is known and/or familiar (e.g., where the token service provider 114a transmits the generated token to the routing payment network 106, where the routing payment network includes the token vault data structure, etc.), the routing payment network 106 is configured to convert or map that token to an account number (e.g., the PAN, etc.) for the consumer's payment account (e.g., based on a token map available to the routing payment network 106, etc.) and to append the account number to the authorization request (in addition to, or in place of, the token). The routing payment network 106 then routes the authorization request to the issuer 110 (as indicated by the account), along path A.

However, if the routing payment network 106 determines that the token is not known and/or familiar (e.g., where, as described above, the token service provider 114a instead provides the generated token to the payment network 108, etc.), the routing payment network 106 is configured to initiate a service request network message to the payment network 108 (comprising at least the token from the authorization request) (e.g., to another one of MasterCard®, VISA®, Discover®, American Express®, etc.), and specifically, to the token vault data structure 120 associated therewith (along path B in FIG. 1). In turn, the payment network 108 is configured to search for the token included in the service request network message and to convert the token to an account number (e.g., the PAN, etc.), based on the listing of tokens included in the token map in the token vault data structure 120. The payment network 108 is configured to then return the identified account number to the routing payment network 106 (back along path B). In response, the routing payment network 106 is configured to append the account number to the authorization request (in addition to, or in place of, the token) and to route the authorization request to the issuer 110 (again, as indicated by the PAN).

In either case, upon receipt of the authorization request, the issuer 110 is configured to determine if the consumer's payment account is in good standing (e.g., if the consumer 118 has timely made at least one payment for any outstanding balance associated with the payment account, if there are no overdue balances for the payment account, etc.) and if there is sufficient funds and/or credit to cover the transaction. In addition, and as applicable, the issuer 110 is configured to validate any cryptogram included in the authorization request. Then, if the transaction is approved/validated by the issuer 110, the issuer 110 is configured to transmit an authorization reply (indicating the approval of the transaction) back to the acquirer 104 and the merchant 102, via the routing payment network 106, again along path A, thereby permitting the merchant 102 to complete the transaction. The authorization reply typically includes the token and the PAN, in whole or in part (e.g., the authorization reply may include the token and the last four digits of the PAN, etc.). Clearing and settlement of the transaction may then be performed based on the PAN for the consumer's payment account (as the PAN is available to both payment networks 106 and 108). And, the issuer 110 is configured to transmit transaction history detail to the computing device 116, as desired.

The transaction, when approved, is later cleared and/or settled by and between the merchant 102, the acquirer 104, and the issuer 110. If the transaction is declined by the issuer 110, however, an authorization reply (indicating a decline of the transaction) is provided by the issuer 110 back to the merchant 102, thereby permitting the merchant 102 to halt or terminate the transaction or to request an alternative form of payment.

While the system 100 is described above in connection with tokenization of account numbers for payment accounts, it should be appreciated that the system 100 may also be implemented in connection with Automated Clearing House (ACH) transactions (and tokenization of account numbers in connection therewith). For example, ACH transactions generally permit originating financial institutions to deposit and/or withdraw funds to/from accounts, based on permissions from account holders associated with the accounts. Such ACH transactions are often used, for example, to fund transactions involving utility bills, tax bills, and other bills via bill pay applications, and to deposit funds associated with directly deposited wages and tax refunds (among others). In connection therewith, consumer's associated with the accounts may provide tokens for use in the transactions in lieu of account numbers. As such, in connection with processing the transactions, the tokens may be stored in the common token vault data structure 120 as discussed above, or in another common data structure (e.g., apart from the payment network 108, etc.), whereby an ACH network may then request an account number for a given account based on a token provided by a consumer in connection with an underlying ACH transaction.

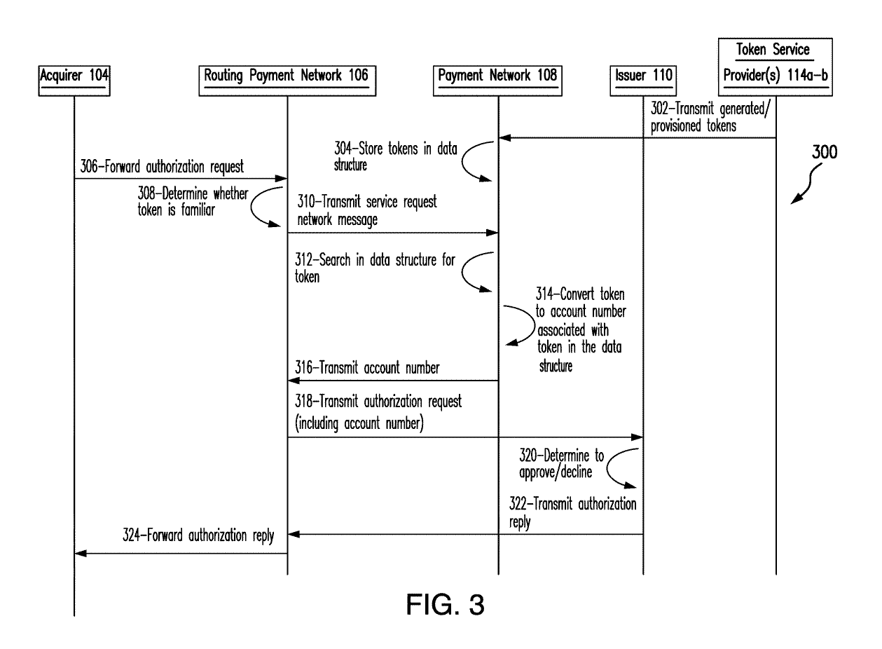

FIG. 3 illustrates an exemplary method 300 for use in converting tokens to payment account numbers. The exemplary method 300 is described with reference to the system 100, and as implemented in the acquirer 104, the routing payment network 106 (and the token vault data structure 120), the payment network 108, and the issuer 110, for example, and further with reference to computing device 200. However, it should be understood that the method 300 is not limited to this configuration of the system 100, as the method 300 may be implemented, at least in part, in other parts in system 100, or in multiple other computing devices or systems. As such, the methods herein should not be understood to be limited to the exemplary system 100 or the exemplary computing device 200, and likewise, the systems and the computing devices herein should not be understood to be limited to the exemplary method 300.

At the outset in the method 300, the payment network 108 accumulates tokens from multiple token service providers, including the token service providers 114a-b. Specifically, as shown in FIG. 3, the token service providers 114a-b transmit generated and/or provisioned tokens to the payment network 108, at 302 (e.g., at the request of consumers associated with underlying payment accounts, at the request of merchants involved in transactions with the consumers, etc.). In turn, the payment network 108 receives the tokens form the token service providers 114a-b, and then, at 304, stores the tokens in a listing of tokens (or in a token map) within the token vault data structure 120. The tokens are stored in association with the payment accounts for which the tokens are issued, so that the payment accounts may be subsequently identified in the listing of tokens based on the tokens.

Subsequently in the method 300, the consumer 118 performs a transaction at the merchant 102 using his/her payment account (as generally described above in the system 100). In connection therewith, the consumer 118 presents the token for his/her payment account to the merchant 102 (as provided by the token service provider 114a) in lieu of the account number. The merchant 102 receives the token and compiles an authorization request for the transaction (e.g., including the token associated with the account; an amount of the purchase; a cryptogram associated with enhanced authentication operations, if any; etc.). The merchant 102 then transmits the authorization request to the acquirer 104.

In turn, at 306, the acquirer 104 forwards the authorization request for the transaction, from the merchant 102, to the routing payment network 106. Upon receipt of the authorization request, the routing payment network 106 determines, at 308, whether the token is familiar or known to the routing payment network 106. Specifically, for example, the routing payment network 106 may include or be associated with one or more token service providers (such as the token service providers 114a-b), where the payment network 106 (directly or indirectly) generates and/or provisions tokens for payment accounts (such as to the consumer 118). As such, certain tokens may be familiar or known to the routing payment network 106, whereby it is able to convert the tokens (via a token vault data structure) to the corresponding account numbers directly and without interacting with the payment network 108. When the token, therefore, is familiar to the routing payment network 108, the method 300 is ended, and the routing payment network 106 continues as is conventional in connection with tokenized transactions.

Conversely, if the token is unfamiliar or unknown to the routing payment network 106, the routing payment network 106 transmits, at 310, a service request network message (broadly, a request or a network request message) to the payment network 108. The network message may include, for example, an ISO 8583 message, such as an 0100 request message, an 0120 request message, an 0400 request message, or another ISO request message, etc. Alternatively, the message to the payment network 108 may include a call to an application programming interface (API) exposed by the payment network 108. Regardless of the form, the message includes the consumer's token presented in the transaction. In response, the payment network 108 converts the token to the account number for the consumer's payment account. In particular, the payment network 108 accesses the token vault data structure 120 and searches, at 312, within the token maps in the token vault data structure 120 for the token. When the token is identified, the payment network 108 converts, at 314, the token to the account number identified in the search as being associated with the token. The payment network 108 then transmits the identified account number, at 316, back to the routing payment network 106, via a response message, such as, for example, an 0110 response message (to an 0100 request message), an 0130 response message (to an 0120 request message), an 0410 response message (to an 0400 request message), or an API response, etc.

Upon receiving the account number for the consumer's payment account from the payment network 108, the routing payment network 106 appends the account number to the authorization request (in place of the token or in addition to the token) and transmits, at 318, the authorization request to the issuer 110 of the payment account. For example, the account number permits the routing payment network 106 to identify the specific issuer 110 associated with the consumer's payment account (e.g., based on a bank identification number (BIN) range included in the PAN for the payment account, etc.). What's more, where the routing payment network 106 applies value added services, based on the identified issuer 110, and/or the identified BIN range, etc., the routing payment network 106 is further able to appropriately apply the services when the account number is received from the payment network 108 and identified to the specific one or more of the value added services.

In turn, the issuer 110 determines, at 320, whether to approve the transaction, or not, based in part on the account number included the authorization request. In connection therewith, for example, the issuer 110 may determine if the consumer's account associated with the account number is in good standing. In addition, the issuer 110 may validate a cryptogram included in the authorization message (when such cryptogram is present). Or, the one of the payment networks 106 and 108 may validate the cryptogram in the authorization message on behalf of the issuer 110 (e.g., where the one of the payment networks 106 and 108 include the issuers keys to allow for decrypting the cryptogram, etc.). When the issuer 110 determines to approve (or decline) the transaction, the issuer 110 compiles and transmits, at 322, an authorization reply to the routing payment network 106. The authorization reply includes the account number for the consumer's payment account (e.g., the PAN, etc.) and an indication of whether the transaction is approved or declined. In addition, in some implementations of the system 300, the authorization replay may also include the token. The routing payment network 106 then forwards the authorization reply to the acquirer 104, at 324, whereupon the acquirer 104 is able to provide the authorization reply to the merchant 102 (so that the merchant 102 can continue in the transaction (when approved), or halt the transaction (when declined)).

In addition in the method 300, the issuer 110 (and not the routing payment network 106) may transmit transaction details, or a transaction history, to the consumer 118 at the payment application through which the token was issued, or other network-based application, at the computing device 116.

It should be appreciated that in various transactions the payment network 108 may operate as the routing payment network, for example, when authorization requests for transactions are provided to the payment network 108. As such, the payment network 108 is also generally able to receive authorization requests and to transmit the authorization requests to the issuer 110, for example, consistent with the description herein. What's more, in various transactions (and as generally described above) the routing payment network 106 may include the token vault data structure, whereby transactions routed through the routing payment network 106 and including the token may be mapped to the consumer's payment account by the routing payment network 106, via the token vault data structure.

In view of the above, the systems and methods herein permit a routing payment network to properly route transaction messages even when the messages include tokens that are unfamiliar and/or unknown to the routing payment network. As such, when a non “front of card” payment network is involved in a transaction, based on the type of the transaction and/or a location of the transaction, for example, a token included in the corresponding transaction message is not problematic for the routing payment network. Rather, the routing payment network is able to transmit a service request network message to retrieve the payment account number (e.g., PAN, etc.) associated with the token and continue in the transaction. In connection therewith, another payment network may include a token vault data structure, in which tokens are stored from one or multiple token service providers, to thereby provide a central handling of token-inclusive network messages and detokenization of the same. As such, efficiencies are gained by the central handling of the tokens, at the data structure, in that routing payment networks are able to handle network messages by interaction with the central data structure, regardless of whether the tokens included in the messages are known to the routing payment network, or not.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, by a payment network computing device, a token provisioned to a payment account and storing the token in a data structure coupled to the computing device; (b) receiving, by the payment network computing device, a request from a routing payment network for an account number associated with the payment account in connection with a purchase transaction involving the payment account, the request including the token provisioned to the payment account but not an actual account number for the payment account; (c) identifying the token in the data structure and converting, by the payment network computing device, the token to the account number for the payment account; (d) transmitting, by the payment network computing device, the account number to the routing payment network, whereby the routing payment network can append the account number to an authorization request for the transaction in connection with directing the authorization request to an issuer of the payment account thereby permitting the issuer to approve or decline the transaction based, at least in part, on the account number appended to the authorization request; (e) receiving, by the payment network computing device, an authorization request associated with a second transaction, the authorization request including a second token associated with a second payment account; (f) converting, by the payment network computing device, the second token to a second account number associated with the second payment account based on a listing of tokens in the data structure; and (g) transmitting, by the payment network computing device, the authorization request associated with the second transaction, including the second account number, to an issuer of the second payment account, thereby permitting the issuer to approve or decline the second transaction.

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in processing network transactions to accounts, where the transactions are based on network messages including tokens, the system comprising:
a network including a memory and at least one processor coupled to the memory, the memory including a token vault data structure having a listing of tokens stored therein, whereby each token stored in the memory is associated with an account number;
wherein the at least one processor is configured to:
receive a network request message from a routing network different than said network, the network request message including a token associated with an account involved in a transaction but not including an actual account number used in the transaction;
in response to the network request message, convert the token to an account number associated with said account, based on the listing of tokens in the token vault data structure; and
transmit the account number to the routing network, thereby permitting the routing payment network to rout the transaction to the account based on use of the token in the transaction.

2. The system of claim 1, wherein the network includes a first payment network and the routing network includes a second payment network different from the first payment network.

3. The system of claim 2, wherein the at least one processor is further configured to search, in the token vault data structure, for the token, prior to converting the token to the payment account number associated with said payment account.

4. The system of claim 2, wherein the account includes a payment account, and wherein the account number associated with the payment account includes a primary account number (PAN).

5. The system of claim 4, wherein the network request message includes an ISO 8583 message.

6. The system of claim 4, wherein the network request message includes an application programing interface (API) call to the payment network.

7. The system of claim 4, wherein the at least one processor is further configured to:
receive an authorization request associated with a second transaction, the authorization request including a second token associated with a second payment account;
convert the second token to a second account number associated with the second payment account based on the listing of tokens in the token vault data structure; and
transmit the authorization request, including the second account number, to an issuer of the second payment account, thereby permitting the issuer to approve or decline the second transaction.

8. The system of claim 2, wherein the second payment network includes a front of card payment network for the account.

9. The system of claim 1, wherein the at least one processor is further configured to:
receive tokens from multiple different token service providers for multiple accounts; and
store the received tokens in association with account numbers for the multiple accounts in the listing of tokens in the token vault data structure.

10. The system of claim 1, wherein the network is a payment network; and
further comprising at least one of the multiple different service providers in communication with the at least one processor.

11. The system of claim 1, wherein the routing network includes an automated clearing house (ACH) network.

12. A method for processing network transactions to payment accounts, where the transactions are based on network messages including tokens, the method comprising:
receiving, by a payment network computing device, a token provisioned to a payment account and storing the token in a data structure coupled to the computing device;
receiving, by the payment network computing device, a request from a routing payment network for an account number associated with the payment account in connection with a purchase transaction involving the payment account, the request including the token provisioned to the payment account but not an actual account number for the payment account;
identifying the token in the data structure and converting, by the payment network computing device, the token to the account number for the payment account; and
transmitting, by the payment network computing device, the account number to the routing payment network, whereby the routing payment network can append the account number to an authorization request for the transaction in connection with directing the authorization request to an issuer of the payment account thereby permitting the issuer to approve or decline the transaction based, at least in part, on the account number appended to the authorization request.

13. The method of claim 12, wherein storing the token in the data structure includes mapping the token to the account number for the payment account.

14. The method of claim 13, wherein the account number includes a primary account number (PAN) for the payment account; and
wherein the routing payment network includes a front of card payment network for the payment account.

15. The method of claim 12, further comprising:
receiving, by the payment network computing device, an authorization request associated with a second transaction, the authorization request including a second token associated with a second payment account;
converting, by the payment network computing device, the second token to a second account number associated with the second payment account based on a listing of tokens in the data structure; and
transmitting, by the payment network computing device, the authorization request associated with the second transaction, including the second account number, to an issuer of the second payment account, thereby permitting the issuer to approve or decline the second transaction.

16. The method of claim system of claim 12, wherein the request includes an ISO 8583 message.

17. The method of claim 12, wherein the request includes an application programing interface (API) call to the computing device.

18. A non-transitory computer readable storage media comprising executable instructions for processing network transactions to accounts, which, when executed by at least one processor associated with a first payment network, cause the at least one processor to:
store, in a data structure associated with the first payment network, a token provisioned to a payment account in association with an account number for the payment account;
receive, from a second payment network, a network message requesting the account number of the payment account in connection with a purchase transaction involving the payment account, the network message including the token provisioned to the payment account but not the actual account number for the payment account;
retrieve the token from the network message and convert the token to the account number for the payment account, based on a mapping of the token to the account number in the data structure; and
append the account number to a network message and transmit the network message to the second payment network, in response to the network message requesting the account number, whereby the second payment network can append the account number to an authorization request for the purchase transaction in connection with directing the authorization request to an issuer of the payment account.

19. The non-transitory computer readable storage media of claim system of claim 18, wherein the network message requesting the account number and/or the network message transmitted in response thereto includes an ISO 8583 message.

20. The non-transitory computer readable storage media of claim system of claim 18, wherein the network message requesting the account number and/or the network message transmitted in response thereto includes an application programing interface (API) call to the first payment network.
